(19) United States
(12) Patent Application Publication
(10) Pub. No.: US 2012/0082869 A1
(43) Pub. Date: Apr. 5, 2012

(54) Microbial Electrolytic Cell

(75) Inventors: Bruce E. Rittmann, Tempe, AZ (US); Hyung-sool Lee, Waterloo (CA); Cesar I. Torres, Tempe, AZ (US)

(73) Assignee: Arizona Board of Regents, Scottsdale, AZ (US)

(21) Appl. No.: 13/259,523

(22) PCT Filed: Apr. 1, 2010
(86) PCT No.: PCT/US2010/029563

§ 371 Date: Dec. 17, 2011

Related U.S. Application Data
(60) Provisional application No. 61/167,394, filed on Apr. 7, 2009.

(51) Int. Cl. H01M 8/16; C25B 1/02

(52) U.S. Cl. 429/2

(57) ABSTRACT

System and methods for efficiently capturing hydrogen gas from a microbial electrolytic cell. Certain aspects of the invention describe microbial electrolytic cells in which the cathode is located above the anode and proximal to a fluid level and a gas headspace in the single-chamber microbial electrolytic cell. In other aspects, the invention relates to improved and high volumetric production rate of hydrogen gas effected by increasing the geometric surface area of the electrodes. Combinations of these aspects also are contemplated.

### RELATED APPLICATIONS

[Not Applicable]

### FEDERALLY SPONSORED RESEARCH OR DEVELOPMENT

[Not Applicable]

### BACKGROUND OF THE INVENTION

A. Field of the Invention

Embodiments of the present invention relate generally to a system and method for efficiently capturing hydrogen gas from a microbial electrolytic cell (MEC). In particular, embodiments of the present invention concern the systems and methods where the cathode is located above the anode and proximal to a fluid level and a gas headspace in a single-chamber microbial electrolytic cell. In other embodiments, the MEC is formed using graphite small fiber bundles to decrease reactor volume and thereby increase the volumetric H₂ rate of the MEC.

B. Description of Related Art

There is an ever-increasing demand for energy conversion devices that may be used to produce electricity using non-fossil fuel technologies. In this regard, renewable fuels are employed in microbial fuel cells to generate Hydrogen (H₂).

H₂ can become a significant contributor to global energy sustainability if it is produced from renewable, non-fossil fuel resources (e.g., biomass). A microbial electrolytic cell (MEC) can be attractive as an alternative to biological H₂ production out of organic compounds. The MEC uses specific bacteria, called anode-respiring bacteria (ARB) that can transfer electrons extracted from organic donors to the anode in the MEC. The electrons transported to the anode pass through a circuit and reach the cathode, where the electrons react with H⁺ ions (or H₂O) to produce H₂.

MECs have two main advantages over other biohydrogen processes. First, a variety of organic donor substrates can be used as fuel, such as glucose, cellulose, acetate, butyrate, lactate, propionate, or valerate (Cheng et al., 2007), by using bacterial consortia involving fermenters and ARB (Ren et al., 2007; Lee et al., 2008). Second, non-fermentable substrates can be completely oxidized to CO₂, resulting in high conversion yields of 67-91% (Cheng et al., 2007).

An MEC involves two redox steps. The first redox step is oxidation of an electron donor by the ARB, with electrons transferred to the anode. The coulombic efficiency (CE) is the ratio of electron equivalents (e⁻ equiv) converted to electrical flow (i.e., coulombs) normalized to the number of e⁻ equiv consumed from the organic donor. The second redox step is a reduction in which the electrons transferred through the circuit react with H⁺ (or H₂O) at the cathode and produce H₂. The cathodic conversion efficiency (CCE) is the ratio of e⁻—equivalents donated to H₂ normalized to the e⁻ equivalents transferred in the circuit from the anode to the cathode. A CCE less than 100% means that H₂ produced on the cathode gets lost to other reactions (e.g., diffusion to an anode compartment, leak from an MEC, or biological oxidation). The H₂ yield is the product of CE and CCE and it can be computed by

$${H}^{2} yield = CE \times CCE = \frac{{coulombs}_{cum}}{Δ {e}^{-} donor} \times \frac{{H}_{2 , obs}}{{coulombs}_{cum}} \qquad ( 1 )$$

where Δ e⁻ donor is electron donor removed by ARB in a given time (e⁻ equiv), coulombs_{cum} are cumulative coulombs transferred to an anode in a given time (e⁻ equiv), and H_{2,obs} is H₂ volume measured in a given time (e⁻ equiv).

Equation (1) illustrates that the ability to achieve a high H₂ yield depends on a high CE, which can only be obtained when the e⁻ equivalents of the donor substrate do not get “lost” before they are transferred to the anode. Possible e⁻ sinks that decrease CE include biomass synthesis, soluble microbial products (SMP), or CH₄ gas. H₂O can also be a significant electron sink if O₂ leaks into the anode compartment. Lee et al. (2008) showed that biomass (15-26%) and SMP-like organics (11-18%) were the largest non-electricity sinks in an MFC that had no O₂ leakage.

The ability to achieve a high H₂ yield also requires that the CCE is high. Rozendal et al. (2007) reported a CCE close to 100% in a dual-chamber MEC. However, H₂ loss by diffusion into an anode chamber was large in some cases (Rozendal et al., 2008), decreasing CCE down to 6-33%. Two studies tested single-chamber MECs (Call and Logan, 2008; Hu et al., 2008), but they showed unstable CCEs in the range of 28-96% (Call and Logan, 2008).

The most likely sink for H₂ in a single-chamber MEC would seem to be hydrogenotrophic methanogens that consume the H₂ produced at the cathode before it can be recovered (Lee et al., 2008, Hu et al., 2008). Up to now, no studies quantified H₂ consumed by the methanogens in a single-chamber MEC although CH₄ gas was observed (Call and Logan, 2008; Hu et al., 2008). Another H₂ sink can be oxidation by ARB, if they are able to utilize H₂ as an electron donor (Torres et al., 2007; Bond and Lovley, 2003). Although H₂ oxidation by ARB might not be a significant H₂ loss in a single-chamber MEC, since current produced by H₂ oxidation produces H₂ gas on the cathode again; it increases ohmic losses of electrical potential which is undesired.

To ensure a high CCE when hydrogenotrophic methanogens are a risk, one can try to inhibit H₂-utilizing methanogenesis with a specific inhibitory (e.g., BES), intermittent exposure to air, an acidic pH, or a short solids retention time (SRT). Using inhibitors is generally not practical for field applications, due to their expense, toxicity potential, or difficult handling. Exposure to air also is generally not practical, because it adds an alternative electron sink that will reduce the CE significantly. Hu et al. (2008) attempted to use an acidic pH for preventing the methanogens' growth, but it was not effective. In addition, an acidic pH could lower the current, since substrate-utilization rates are inhibited in acidic pH (Torres et al., 2008). Short SRT less than 0.76 d can be efficient for depressing the methanogens' activity, since absolute minimum SRT of the archaea is 0.76 d (Rittmann and McCarty, 2001) in contrast to infinite SRT of ARB biofilm on the anode. However, the SRT strategy demands that methanogens not accumulate in the biofilm.

As a practical matter, a second significant challenge with MECs may be that H₂ production rates are slow, which increases reactor size and cost. One means to overcome the negative effects of the lower kinetics is to increase the MEC surface area by orders of magnitude to give high volumetric H₂ production capacity.

### BRIEF SUMMARY OF THE INVENTION

In some aspects the present invention relates generally to a system and method for efficiently capturing hydrogen gas from a microbial electrolytic cell. In particular, embodiments of the present invention concern the systems and methods where the cathode is located above the anode and proximal to a fluid level and a gas headspace in a single-chamber microbial electrolytic cell.

In certain other aspects of the invention, there is provided a microbial electrolytic cell comprising a reservoir containing a fluid; an organic donor material contained within the reservoir; an anode submerged in the fluid; anode-respiring bacteria proximal to the anode; and a cathode, wherein the anode and the cathode are each comprised of at least one bundle of non-bonded graphite small fibers.

A further aspect of the invention contemplates a microbial electrolytic cell comprising: a reservoir containing a fluid; an organic donor material contained within the reservoir; an anode submerged in the fluid; anode-respiring bacteria proximal to the anode; and a cathode, wherein the cathode is located above the anode and proximal to an upper level of the fluid contained within the reservoir. In certain specific embodiments, the anode comprises graphite rods.

In particular embodiments, the electrolytic cell of the invention is one in which the anode and the cathode are not separated by a membrane.

Yet another aspect of the invention contemplates a microbial electrolytic cell comprising: a reservoir containing a fluid; an organic donor material contained within the reservoir; an anode submerged in the fluid; anode-respiring bacteria proximal to the anode; and a cathode, wherein the cathode is located above the anode and proximal to an upper level of the fluid contained within the reservoir, wherein the anode and the cathode are each comprised of at least one bundle of non-bonded graphite small fibers.

In those embodiments in which the cathode and anode are comprised of one or more bundles of non-bonded graphite small fibers, each of the bundles comprises between about 15,000 and 50,000 graphite fibers wherein each graphite small fiber independently comprises a thickness of 0.1-20 μm. In specific embodiments, each graphite fiber of the graphite small fiber bundle independently comprises a thickness of from about 1-10 μm. In more specific embodiments, each graphite small fiber in the bundle independently comprises a thickness of from about 4-8 μm. The amount of fibers physically packed together into each bundle may vary. In exemplary embodiments, each of the bundles independently comprises between about 20,000 and 30,000 graphite small fibers. Typically, the bundle of the cathode electrode is smaller than the anode which forms the surface area on which the bacterial are disposed, for example, the ratio of anode:cathode bundles is between about 2:1 to about 5:1. For example, the anode electrode comprises about 3-10 bundles. In other examples, the cathode electrode comprises about 1-2 bundles.

It is an advantage of the present invention that the MECs may be prepared without the need for metal catalysts. However, in certain embodiments, it may be desirable to include such catalysts, and, therefore the invention contemplates that in certain embodiments, the MECs may be formed where the cathode electrode further comprises a metal catalyst. Exemplary such metal catalysts may be selected from the group consisting of cobalt, copper, iron, lead, nickel, palladium, tin, tungsten, platinum group metals, or an alloy comprising one of more of the group.

In each of the aspects of the invention described herein, the microbial electrolytic cell of the invention may independently further comprise one or more of: 1) a pump to circulate the fluid within the reservoir; 2) a pH measurement device configured to measure the pH of the fluid contained within the reservoir; 3) a gas flow meter configured to measure an amount of H₂ gas produced by the microbial electrolytic cell; 4) a potentiostat configured to apply a voltage between 0.2 volts and 1.2 volts between the anode and the cathode, and 5) a reference electrode electrically coupled to an electrical circuit comprising the cathode and the anode; including combinations of the aforementioned and all five of the aforementioned components.

In specific embodiments, the organic donor material for each of the aspects described herein may be selected from the group consisting of: glucose, cellulose, acetate, butyrate, lactate, propionate, or valerate. In other embodiments, the organic donor material is an organic waste material. For example, the organic waste material may be selected from the group consisting of: sewage, human waste, animal waste, and industrial waste.

In the various microbial electrolytic cells of the invention, the anode-respiring bacteria transfer electrons extracted from the organic donor material to the anode. Preferably, the microbial electrolytic cell is configured so that the electrons extracted from the organic donor material and transferred to the anode will react with H+to produce H₂ gas at the cathode.

In specific embodiments, the anode bundles and the cathode bundle are less than 3.0 cm apart, more particularly, the anode bundles and the cathode bundle are approximately 2.0 cm apart.

Also contemplated herein are methods of producing hydrogen gas. An exemplary such method comprises providing a microbial electrolytic cell of the invention; inducing a transfer of electrons from the organic donor material to the anode; and reacting the electrons with H⁺ or H₂O proximal to the cathode to produce hydrogen gas. Preferably, the inducing the transfer of electrons from the organic donor material to the anode involves applying a voltage between the anode and the cathode.

Also contemplated are methods of increasing the rate of hydrogen gas production in a microbial electrolytic cell comprising providing the microbial electrolytic cell that comprises an anode, a cathode, a fluid reservoir, and a population of ARBs accumulated on the anode, wherein at least the anode is comprised of at least one bundle of non-bonded graphite small fibers; inducing a transfer of electrons from the organic donor material to the anode; and reacting the electrons with H⁺ or H₂O proximal to the cathode to produce hydrogen gas; wherein the microbial electrolytic cell comprising the anode of non-bonded graphite small fibers produces more hydrogen gas per minute than a similarly configured microbial electrolytic cell that comprises an anode prepared from a single graphite rod or an anode prepared from porous graphite.

The method also may be advantageously enhanced where the cathode electrode of the microbial electrolytic cell also is comprised of at least one bundle of non-bonded graphite small fibers. In additional embodiments, the cathode electrode may further comprise a metal catalyst.

It is contemplated that any embodiment discussed in this specification can be implemented with respect to any method or system of the invention, and vice versa. Furthermore, systems of the invention can be used to achieve methods of the invention.

The term “conduit” or any variation thereof, when used in the claims and/or specification, includes any structure through which a fluid may be conveyed. Non-limiting examples of conduit include pipes, tubing, channels, or other enclosed structures.

The term “reservoir” or any variation thereof, when used in the claims and/or specification, includes any body structure capable of retaining fluid. Non-limiting examples of reservoirs include ponds, tanks, lakes, tubs, or other similar structures.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The terms “inhibiting” or “reducing” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

Other objects, features, and advantages of the present invention will become apparent from the following detailed description. It should be understood, however, that the detailed description and the examples, while indicating specific embodiments of the invention, are given by way of illustration only. Additionally, it is contemplated that changes and modifications within the spirit and scope of the invention will become apparent to those skilled in the art from this detailed description.

### BRIEF DESCRIPTION OF SEVERAL VIEWS OF THE DRAWINGS

FIG. 1 is a schematic view of an exemplary embodiment of microbial electrolytic cell system according to the present disclosure.

FIG. 2(a) is a graph illustrating the applied voltage and volumetric current density versus time for the embodiment of FIG. 1 under certain operating conditions.

FIG. 2(b) is a graph illustrating the coulombic efficiency (CE), cathodic conversion efficiency (CCE), and acetate concentration for the embodiment of FIG. 1 under certain operating conditions.

FIG. 3 is a graph illustrating the cathodic conversion efficiency (CCE) for the embodiment of FIG. 1 under varying operating conditions.

FIG. 4 is a schematic diagram of an upflow single-chamber MEC using graphite small-fiber bundles as electrodes. P—a potentiostat for power supply. The cathode bundle was separated from the anodes using a non-conductive mat.

FIG. 5 shows the evolution of volumetric current density and H₂ production rate with HRT.

FIG. 6 shows the E_{anode} effect on volumetric current density and applied voltage.

### DETAILED DESCRIPTION OF THE INVENTION

There is a need to maximize the H₂ yield by having a CCE near to 100%. In a first embodiment, this need is met by the present invention by placing a cathode close to the water level in a MEC.

In a further embodiment, it has now been discovered that using graphite small fiber bundles as the anode in a MEC can advantageously increase the current density and rate of H₂ production.

Thus the present invention contemplates 1) MECs in which the a cathode is placed close to the water level in the MEC; 2) MECs in which the anode is comprised of electrodes of increased specific surface area; and 3) a combination of embodiments 1 and 2 in which the cathode is placed close to the water level in an MEC in which the anode is made of graphite small fiber bundles.

A. MECs Comprising a Cathode Proximal to an Upper Level of the Fluid Contained within the Reservoir.

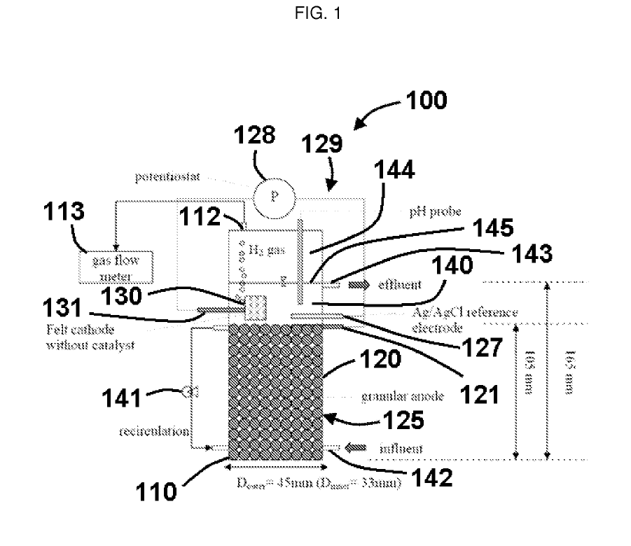

Referring now to FIG. 1, a microbial electrolytic cell (MEC) 100—comprises a reservoir 110, an anode 120, a cathode 130 and a fluid 140 maintained at a fluid level 145. In this specific embodiment, the anode 120 comprises a plurality of graphite rods coated with anode-respiring bacteria (ARB) 125, and cathode 130 comprises a carbon felt. In the embodiment shown, anode 120 and cathode 130 are electrically coupled to form an electrical circuit 129, which also comprises a potentiostat 128 and a reference electrode 127. Electrical circuit 129 may also comprise a graphite rod 131 inserted into cathode 130 and a graphite rod 121 inserted into anode 120.

In the embodiment shown, MEC 100 also comprises a pump 141 configured to recirculate fluid 140 from a lower portion of anode 120 to an upper portion of anode 120. An inlet 142 allows fluid 140 to enter reservoir 110, and an outlet 143 maintains fluid 140 at fluid level 145. A gas headspace 144 is located above fluid level 145 and below the upper portion 111 of reservoir 110. In this embodiment, fluid 140 also comprises an organic donor material (not visible in FIG. 1) such as acetate.

During operation of MEC 100, potentiostat 128 can be used to apply a voltage between anode 120 and cathode 130 and cause a negative potential at cathode 130. ARB 125 will transfer electrons extracted from the organic donor material to anode 120. The electrons transported to anode 120 pass through an electrical circuit 129 and reach cathode 130, where the electrons react with H⁺ ions (or H₂O) to produce H₂. As shown in FIG. 1, cathode 130 is placed proximal to anode 120. Specifically, cathode 130 is placed above anode 120 and below fluid level 145. In exemplary embodiments, cathode 130 is proximal to fluid level 145 so that the majority of H₂ gas produced by MEC 100 enters gas headspace 144 rather than being consumed by methanogens or other potential H₂ sinks present in MEC 100. Since the solubility of the H₂ molecule is extremely low (K_{H}=7.65×10⁻⁴ mol/L-atm at a temperature of 30° C.) (CRC, 2008), rapid recovery of H₂ gas should be feasible if the configuration of MEC 100 is optimized for this purpose. Reservoir 110 also comprises a gas outlet 112 that allows H₂ gas produced by MEC 100 to flow through a gas flow meter 113.

It is understood that FIG. 1 represents one exemplary embodiment of the present disclosure, and other embodiments may comprise a different configuration, including for example, such as a cross-flow reactor, a completely stirred reactor, a sequencing batch reactor, and a reactor using a membrane for gas separation.

B. MECs Comprising an Increased Electrode Surface Area

In an MEC, the anode may be comprised of any material that allows conduction of electrons, such as solid graphite, porous graphite, packed graphite powder, carbon cloth, carbon felt, carbon paper, carbon wool, carbon fibers, a conductive metal, a conductive polymer and combinations of any of these. See Rosenbaum et al. (2007); Qiao et al. (2007).

Using an electrode with a high specific surface area can increase the electrode area without concomitantly changing the volume of the electrode. A variety of approaches may be used to increase an electrode's surface area. In some embodiments, the specific surface area of electrode may be increased by fabricating the electrode from many pieces of thin electrode “fibers” into a bundle to form the complete electrode.

The thickness of each fiber in the bundle may range from a few nanometers to micrometers and the distance between the fibers within the bundle is within a few nanometers.

In order to take advantage of increased surface area effects for improving H₂ production rate in the MEC, the present invention uses a large geometric surface area for ARB-biofilm density to be high in given system volume. In doing so, the electrode surface area is selected such that it is large enough for ARB-biofilm to form (at least larger than 1-2 μm), and electrode must give large surface areas as much as possible in given reactor volumes.

In the present invention, graphite-fiber bundles are used as electrodes. This fiber bundle differs from conventional graphite-fiber used in water electrolysis or chemical fuel cells in that each fiber is not bonded to other fibers in the bundle to form one electrode, such as seen in graphite felt. Instead, many individual graphite fibers each of a thickness of 4.5-8.4 μm are merely physically bundled together, but not bonded. Each fiber in the bundle is able to freely move according to the advection flow of liquid fuel, and thus ARB-biofilm can be well distributed to the bundle of fibers. This flexible movement of each fiber of the bundle is ideal for biofilm formation. In addition, the bundle design is simple method to increase surface areas in given reactor volume.

The geometric surface areas can readily be increased by adding more bundles to a given reactor without any mechanical or chemical fabrication processes. In the experimental details provided in Example 2, an exemplary bundle is prepared in which there are 24,000 graphite fibers, and the geometric surface area per bundle is 1,033 cm². Three such bundles were used as the anode, and thus geometric surface area per the MEC volume is 2,583 m²/m³ for the anode. The cathode may be likewise configured, and in an exemplary embodiment shown in Example 2 below, the cathode is comprised of one bundle.

In specific embodiments, the individual graphite fibers in the bundle have a thickness of between 0.1-20 μm. Preferably, the fibers have a thickness of 1-10 μm, more preferably between about 4-8 μm. Any given graphite fiber bundle may be comprised of 10,000-100,000 individual such fibers compacted or physically configured into a bundle without the use of any chemical processing or other chemical bonding of the individual fibers with other fibers in the bundle. Preferably, the bundle contains between 15,000 and 50,000 graphite fibers. More specifically about 25,000 graphite fibers.

The use of a fiber bundle containing graphite small fibers physically packed into a bundle may be extended to use in any electrolysis cell systems using microorganisms, enzymes, and chemical catalysts on electrodes. This principle for microbial fuel cells or chemical fuel cells (e.g., hydrogen fuel cells) may be used for increasing geometric surface area or specific surface area of the electrodes. These graphite small-fiber bundles can be used for any electrical systems as conductors or semi-conductors requiring large geometric surface area (specific surface area) in given systems, such as electrical monitoring systems, power systems, and signaling systems.

In a specific exemplary embodiment, a single-chamber MEC comprising a cathode proximal to an upper level of the fluid contained within the reservoir such as that described in Section A above is combined with an anode and optionally also a cathode comprised of graphite small fiber bundles. This combination of placing the cathode close to the water level and the use of graphite small fiber bundles allows a further improvement in the capacity of the MEC to produce increased rates of H₂ production.

The use of small-fiber graphite bundles obviates the need to use metal catalysts on the cathode. However, in certain embodiments, it may be desirable nevertheless to include catalysts deposited on the cathode of the MEC. For example, a catalyst is deposited on a gas diffusion layer and/or cation exchange membrane, and the assembled cation exchange membrane, catalyst and gas diffusion layer sandwich is heat treated, such as in a hot press, to form the cathode. A catalyst for catalysis of reduction of oxygen at the cathode is typically a metal catalyst, such as platinum. Further suitable catalyst metals illustratively include cobalt, copper, iron, nickel, palladium, tin, tungsten, as well as platinum group metals, or an alloy of any of these or other catalytic metals. In general, a catalyst, such as platinum, is loaded on a conductive cathode material in amounts in the range of about 0.01 mg/cm²-5.0 mg/cm², inclusive.

C. Microbial Components of the MECs

The microbial catalyst may be any ARB that will consume the fuel source and generate electricity. The fuel source may be any biomass or organic waste that may be consumed by the bacteria to generate hydrogen. Examples of a fuel sources for use with the current invention include glucose, cellulose, acetate, butyrate, lactate, propionate, valerate sugars, cellulose, hemicellulose or chitin. In preferred embodiments, the fuel is acetate which is consumed by the microbial catalyst to generate electricity.

The bacteria used in the MEC may all be a single electrigenic bacterial species or alternatively, it may be preferable to use a plurality of different electrigenic bacterial species.

It should be understood that the term “anode-respiring bacteria” or “ARB” is used herein interchangeably with the term “electricigenic microorganism,” as both terms are often used in the art. An ARB or electricigenic microorganism is any microorganism that will generate electricity without the addition of a mediator. Not to be limited to one theory, the microbial catalyst having an electricigenic activity may catalyze an electrode reduction in a MEC by reducing a soluble mediator that they produce themselves (Bond et al., 2005; Rabaey et al., 2005; Rabaey et al., 2004), or by reducing the electrode through direct contact. Shewanella putrefaciens (Kim et al., 2002) and Geobacter sulfurreducens (Bond et al., 2003) are non-limiting examples of mesobiotic electricigens. Both are Gram-negative bacteria that are capable of reducing insoluble metal oxides external to the cell, a feature common to electricigens. See Lovley (2006). Further exemplary electrigenic microorganisms include, but are not limited to Thermoanaerobacterium thermosaccharolyticum, Thermincola spp. bacteria submitted at GenBank Accession Nos. EU 194830; EU194831; EU194832; EU194833; Thermincola ferriacetica submitted at DSMZ Accession No. 14005; Deferribacteres spp bacteria submitted at EU194827; EU194828; EU194829; EU194834. Other electricigenic bacteria include microrganisms in the family Geobacteraceae, including organisms from any of the genera Geobacter, Desulfuromonas, Desulfuromusa, Pelobacter, and Malonomonas, which are capable of oxidizing organic fuel compounds completely to carbon dioxide and capable of dissimilatory Fe(III) reduction.

Exemplary electricigens include, e.g., Geobacter sulfurreducens. For example, Geobacter sulfurreducens wherein the type strain is strain PCA having ATCC Number 51573 and identified as DSM 12127; Geobacter metallireducens, type species of the genus, wherein the type strain is strain GS-15 having ATCC Number 53774, identified as DSM 7210, and described in Lovley, D. R., et al., Arch. Microbiol., 1993, 159, 336-344; Geobacter argillaceus wherein the type strain is strain G12 having ATCC Number BAA-1139 and also identified as JCM 12999, described in Shelobolina, E. S. et al., Int. J. Syst. Evol. Microbiol., 2007, 57, 126-135; Geobacter bemidjiensis wherein the type strain is strain Bem having ATCC Number BAA-1014, and also identified as DSM 16622 and JCM 12645 and described in Nevin, K. P. et al., Int. J. Syst. Evol. Microbiol., 2005, 55, 1667-1674; Geobacter bremensis wherein the type strain is strain Dfr1 identified as DSM 12179 and as OCM 796 and described in Straub, K. L. and Buchholz-Cleven, B. E. E.), Int. J. Syst. Evol. Microbiol., 2001, 51, 1805-1808; Geobacter chapellei wherein the type strain is strain 172 having ATCC Number 51744 and identified as DSM 13688 and described in Coates, J. D., et al., Int. J. Syst. Evol. Microbiol. 2001, 51, 581-588; Geobacter grbiciae wherein the type strain is strain TACP-2 having ATCC Number BAA-45 and identified as DSM 13689 and described in Coates, J. D. et al., Int. J. Syst. Evol. Microbiol. 2001, 51, 581-588; Geobacter hydrogenophilus wherein the type strain is strain H-2 having ATCC Number 51590 and identified as DSM 13691 and described in Coates, J. D. et al., Int. J. Syst. Evol. Microbiol. 2001, 51, 581-588; Geobacter pelophilus wherein the type strain is strain Dft2, identified as DSM 12255 and as OCM 797, and described in Straub, K. L. and Buchholz-Cleven, B. E. E.), Int. J. Syst. Evol. Microbiol., 2001, 51, 1805-1808; Geobacter pickeringii wherein the type strain is strain G13 having ATCC Number BAA-1140 and identified as DSM 17153 and JCM 13000, described in Shelobolina, E. S. et al., Int. J. Syst. Evol. Microbiol., 2007, 57, 126-135; and Geobacter psychrophilus wherein the type strain is strain P35 having ATCC Number BAA-1013, identified as DSM 16674 and JCM 12644 and described in Nevin, K. P. et al., Int. J. Syst. Evol. Microbiol., 2005, 55, 1667-1674.

At least a first portion of the plurality of electricigenic microbes disposed on an anode in a fuel cell is in direct contact with an anode, forming a biofilm having an average thickness of about the diameter of one microbe of the type in contact with the anode. Electricigenic microbes are disposed on an anode in a fuel cell by inoculating the anode with a substantially pure population of one or more species of isolated electricigenic microbe. The term “isolated” refers to electricigenic microbes separated from the environment in which the microbes are naturally found. The term “substantially pure” refers to a population of microbes wherein at least 95% of the microbes are electricigens of a specified genus or species. In particular embodiments, a substantially pure population of microbes included in a fuel cell according to the present invention refers to a population wherein at least 99% of the microbes are electricigens of a specified genus or species. Thus, for example, a microbe that naturally occurs in saltwater or freshwater sediment is an isolated microbe when separated from the saltwater or freshwater sediment and propagated in culture, resulting in a population of isolated microbes.

The biofilm formed by the bacteria on an anode included in a fuel cell preferably has a thickness greater than about 1 microns. The thickness of a biofilm on an anode may be determined by any of various methods, including, for example, examination of the anode by microscopy. The biofilm may be of a uniform thickness or alternatively may be made of individual colonies of bacteria that are 20 to 50 microns in height joined together through a biofilm that is of a lesser thickness to yield spaced colonies in contact with each other. Spacing the colonies may improve mass transfer of the plurality of electricigenic microbes leading to an improved power density of the microbial fuel cell. The colonies may have a spacing relative to each other in an amount of up to 40 microns.

The thickness of a biofilm on an anode may be described in terms of an amount of microbial protein present on the anode. For example, the electricigenic microbes disposed on an anode in a fuel cell form a biofilm having a range of 0.01 mg microbial protein or less per square centimeter of the surface area of the anode (Bond and Lovley, Appl. Environ, Microbiol. 2003, 69:1548-1555) to 1 mg microbial protein or more per square centimeter of the surface area of the anode.

The amount of microbial protein of a biofilm on an anode is determined by any of various methods, including, for example, using standard protein assays illustratively including Lowrey assay and/or a bicinchoninic acid (BCA) method. Exemplary protein assay methods are described in detail in Lowry, O. H. et al., J. Biol. Chem. 193:265-275, 1951; Hartree, E. F., Anal Biochem 48:422-427, 1972; and Stoscheck, C. M., Quantitation of Protein, Methods in Enzymology 182:50-69, 1990.

D. Applications and Fuel Sources

The MECs of the present invention may be useful for a variety of applications for generating hydrogen. In certain other embodiments, the MECs of the invention may be used for bioprocessing of peach, wood waste, corn stover, switchgrass or any other cellulose-based waste or fuel.

The fuel source for the MECs may be any biomass or organic waste that may be consumed to generate current from the anode. Examples of a fuel sources for use with the current invention include acetate, sugars, cellulose, hemicellulose or chitin. Potential sources of cellulose may include corn stover, peach waste, plant residues, forest litter, chitin and switchgrass. Examples of suitable plant residues include stems, leaves, hulls, husks, cobs and the like, as well as wood, wood chips, wood pulp and sawdust.

### EXAMPLE ONE

In a specific exemplary embodiment, an MEC comprised a glass cylinder with a diameter of 4.5 cm and height of 21.6 cm. Graphite rods (OD 0.8 cm, McMaster-Carr, USA) were cut into 2-3-cm long pieces and packed in the single cell up to a height of 10.5 cm to form the anode bed. The total volume of the single MEC was 161 mL, the empty-bed working volume was 140 mL, the effective working volume was 122 mL (excluding electrode volume), and gas headspace was 21 mL. The reported volumetric current density or volumetric H₂ production rate is based on the empty-bed working volume of 140 mL. The average specific surface area of the granular anode was 4.15 m²/m³ of the empty-bedworking volume. Carbon felt (#43199, Alfa Aesar, MA, USA) without a chemical catalyst was used as the cathode, and its geometric surface area was 21.8 cm².

To connect the electrodes, graphite rods (OD 0.4 cm and length 5.4 cm) were inserted into the top areas of the granule anode, and the cathode felt was penetrated with the rods. The distance between the top layer of the anode bed and the cathode was 2.0 cm. The MEC was mixed by adjusting the circulation flow rates between the bottom and the middle of the MEC. The circulation flow was generated with a peristaltic pump (Masterflex L/S®, Cole-Parmer, USA). The pH values were monitored by placing a pH probe (Cole-Parmer, USA) inside the MEC. An Ag/AgCl reference electrode (BASI Electrochemistry, MF-2052) was placed 1.5 cm over the top of the anode bed, and H₂ gas produced in the MEC was released at the top of the cell and measured using a Milligas counter (Calibrated Instruments, Inc., NY, USA).

In this example, acetate was the electron donor and organic-carbon source to the MEC. In order to select a good ARB biofilm on the anodes, the MEC was acclimated in the continuous mode with a recirculation rate of 20 mL/min using a peristaltic pump (Masterflex L/S®, Cole-Parmer, USA) and a feed rate at 0.88 mL/min. The empty-bed contact time was 2.3 h during continuous operation. When the CE reached a steady-state value of 64±2%, the continuous cell was shifted into batch mode for accurately quantifying the H₂ yield. The acetate concentration was 10 mM, and the internal recycle rate 7 mL/min or 0 mL/min.

The cell was operated at 30±2° C., and the medium pH was 7.3-7.4. The medium was operated in the MEC by operating the cell in continuous mode for 5 hydraulic retention times and a parameter was varied between each experiment. The anode potential (E_{anode}) was fixed at −0.2 V (vs.Ag/AgCl); E_{anode} was +0.07 V vs. the standard hydrogen electrode (SHE). Power was provided to the MEC using a potentiostat (VMP3, Applied Princeton Research, Tennessee, USA), which provided the ability to determine what applied voltage corresponded to the maximum current density.

The current, E_{anode}, cathode potential, and applied voltage were recorded every 120 seconds using EB lab software (Applied Princeton Research, Tennessee, USA).

The CCE was computed (coulombs to H₂), according to Equation (2), and determined the percentage H₂ loss with 100% −CCE.

$$Cathodic conversion efficiency ( \% ) = CCE = \frac{{H}_{2 , obs}}{{coulbombs}_{cum}} \times 100 \qquad ( 2 )$$

Cumulative H₂ volume was measured during a given reaction-time using Equation (3) and converted the H₂ volume into electron equivalence (or vice versa) by using the ideal gas law, described at Equation (4).

$$\begin{matrix}\begin{matrix}{H}_{2 , obs} = Observed {V}_{H 2 , t} \\ = {VH}_{2 , t - 1} + {C}_{H 2 , t} ( {V}_{g , t} - {V}_{g , t - 1} ) + {V}_{head} ( {C}_{H 2 , t} - {C}_{H 2 , t - 1} )\end{matrix} & ( 3 ) \\ {V}_{H 2 , t} ( mL ) = {Coulombs}_{cum} \times \frac{1 m mol {H}_{2}}{2 {e}^{- } m mol} \times \frac{22.4 mL}{1 m mol {H}_{2}} \times \frac{303.15 K}{273.15 K} & ( 4 )\end{matrix}$$

where V_{H2,1}=cumulative H₂ gas volume at time t (mL), V_{H2, t-1}=cumulative H₂ gas volume at time t-1 (mL), V_{g,t}=cumulative total gas volume at time t (mL), V_{g, t-1}=cumulative total gas volume at time t-1 (mL), V_{head}=headspace volume (21 mL) in MEC, C_{H2,t}=H₂ percentage of biogas in headspace at time t, C_{H2, t-1}=H₂ percentage of biogas in headspace at time t-1, and temperature=30° C. (303.15 K).

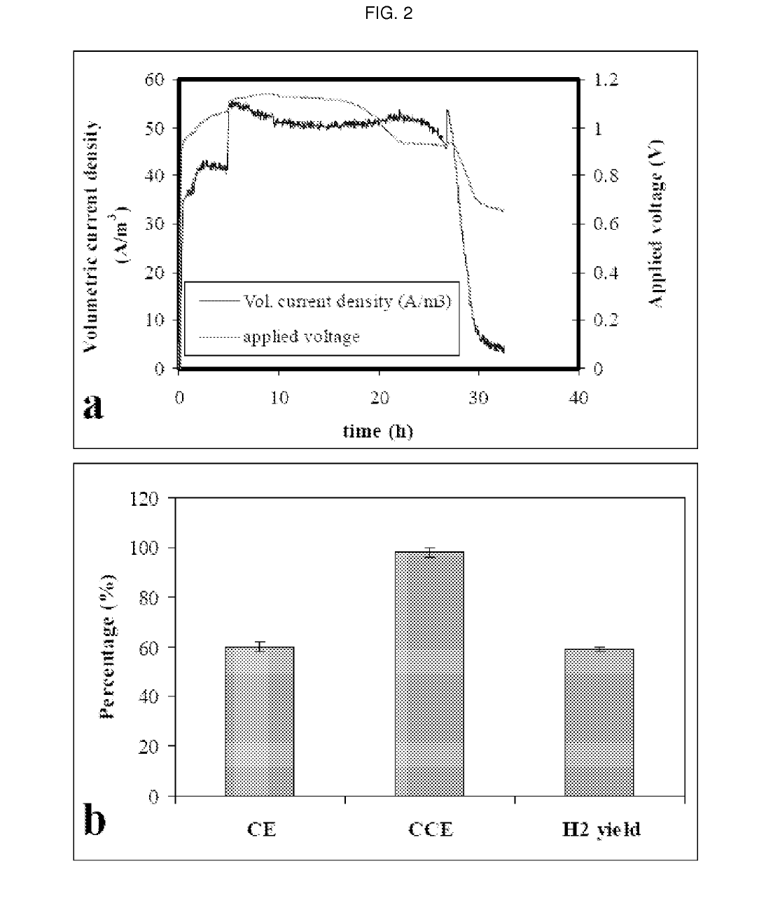

FIG. 2-a shows the applied voltage and volumetric current density with time in the MEC run with a starting acetate concentration of 10 mM and a recirculation rate of 7 mL/min. The average volumetric current density was 51.4±1.6 A/m³ for 6 h to 22 h. The average CCE was 98±2%, the CE was 60±1% (n=3), and the H₂ yield was 59±2% (FIG. 2-b). For this condition, the upflow single-chamber MEC efficiently prevented H₂ loss to methanogenesis, since CH₄ peaks (detected only at the end of the test) were too small to be quantified (<0.5%). To maintain this high CCE is significant, because previous single-chamber MECs had fluctuating CCE in the range of 28-96% (Call and Logan, 2008), and the CCE dropped to 6% in one dual-chamber MEC (Rozendal et al., 2008).

The applied voltage was 1.06±0.08 V for the average volumetric current density (51.4±1.6 A/m³), which equals a volumetric H₂ production rate of 0.57±0.02 m³ H₂/m³-d of MEC working volume. This finding is significant, since this example demonstrates the ability to double the H₂-producing rate over the rate obtained (0.3 m³ H₂/m³-d) with a dual-chamber MEC using Pt catalyst at the cathode and a similar applied voltage (Rozendal et al., 2007), even though there was no chemical catalyst on the cathode.

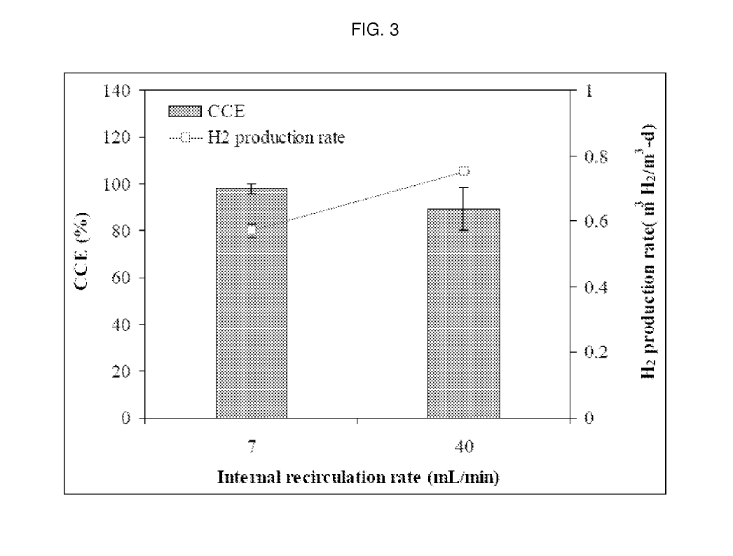

FIG. 3 shows that the higher recirculation rate of 40 mL/min (from the baseline of 7 mL/min) improved the volumetric current density so that its maximum value rose up to 68.1±1.2A/m³ (a 32% increase over the control) at an applied voltage of 1.15±0.03 V. This corresponds to a 0.75-m³ H₂/m³-d production rate. CE was still stable at 60% with the high recirculation rate. The CCE dropped only slightly to 89±9%, with small CH₄ peak (<0.5%) observed at the end of the test. The CE and CCE together gave a H₂ yield of 53.4%. These results show that improved mass-transport could increase acetate utilization rate and current generation with minimal negative impact on the CCE and H₂ yield.

### EXAMPLE TWO

In the present example it is demonstrated that a large geometric surface area formed by the use of many individual graphite fibers packed or bundled into a fiber bundle provides a high H₂ production rate in the MEC. The large geometric surface area produces a high ratio of ARB-biofilm density to MEC system volume. The electrode surface area must be large enough for ARB biofilm to form (at least larger than 1-2 μm), and electrode must have a surface areas as large as possible per reactor volumes, since the ARB biofilm is the catalysts for acetate oxidation on electrode.

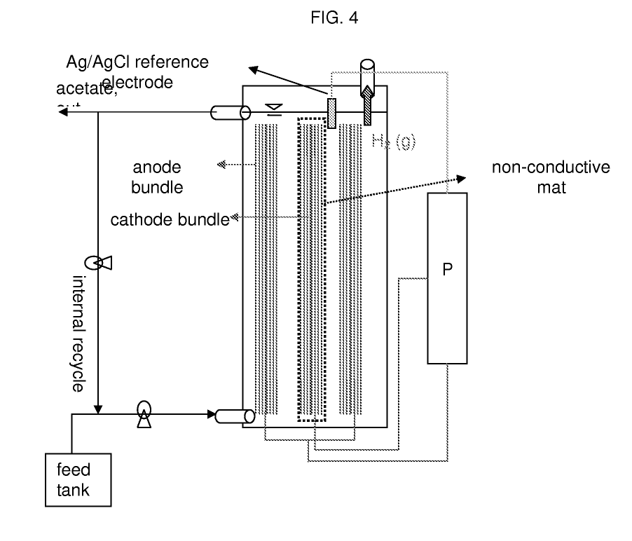

FIG. 4 illustrates the upflow-type single-chamber MEC that was used to test the use of graphite small-fiber bundles as anodes for MECs. The total volume of the MEC was 145 mL, and the working volume was 125 mL. The volumetric current density or volumetric H₂ production rate is reported herein based on the working volume of 125 mL. Three bundles of the graphite fiber were used as the anode and one bundle was used as the cathode. In the current example, metal-catalysts were not used on the cathode. The geometric surface area of the anode per the MEC volume was 2,583 m²/m³.

The cathode was surrounded with a non-conductive mat made up of polyethylene to prevent short-circuiting of the H₂ gas to the anode. The distance between the anode bundles and the cathode bundle was less than 1 cm. The electrodes were connected to a potentiostat (VMP3, Applied Princeton Research, Tennessee, USA) to provide power for the MEC. The MEC was mixed by adjusting the circulation flow rates between the bottom and the middle of the MEC. The circulation flow was generated with a peristaltic pump (Masterflex L/S®, Cole-Parmer, USA) at 7 mL/min. An Ag/AgCl reference electrode (BASI Electrochemistry, MF-2052) was placed 1 cm over the top of the electrodes. Gas produced in the MEC was released at the top of the cell and measured using a Milligas counter (Calibrated Instruments, Inc., NY, USA).

Acetate was used as the electron donor and organic-carbon source to the MEC in all experiments. The MEC was fed in the continuous mode using a peristaltic pump (Masterflex L/S®, Cole-Parmer, USA), and the feed rate ranged from at 0.33 to 1.33 mL/min. The hydraulic retention time (HRT) was at 1.6-6.5 h. The cell was operated at 30±2° C., and the medium pH was 8.3-8.4. The anode potential (E_{anode}) was fixed at −0.3 V (vs. Ag/AgCl) when the HRT was varied. E_{anode} was decreased down to −0.5 V at a fixed HRT of 1.6 h. The current, E_{anode}, cathode potential, and applied voltage were recorded every 120 s using EC lab software (Applied Princeton Research, Tennessee, USA).

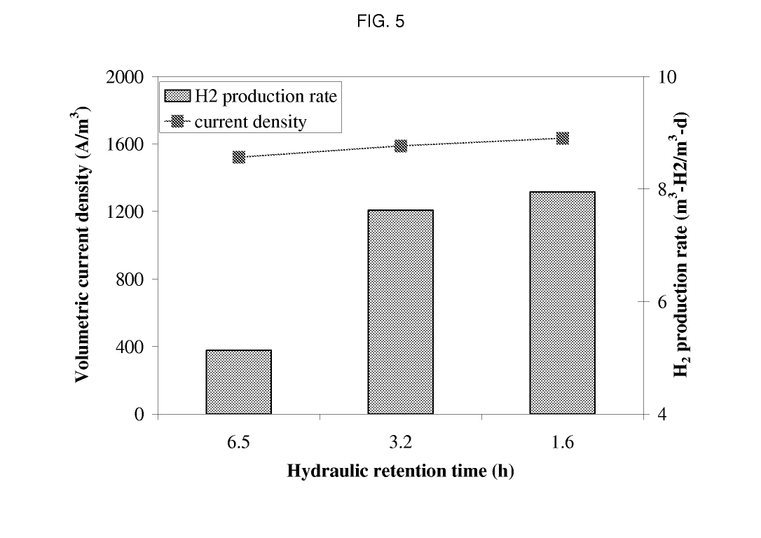

FIG. 5 shows volumetric current density and H₂ production rate for the HRTs tested. Volumetric current density increased from 1,520 to 1,633 A/m³ as HRT was decreased. These volumetric current densities are 30-32 times higher than obtained previously in an MEC using graphite rods (51.4 A/m³ in our study). In addition, the maximum current densities were limited to dozens to a few hundreds A/m³ in the previous MEC using electrodes having high surface areas (Call and Logan, Environ. Sci. Technol. 2008, 42 (9), 3401-3406; Hu et al., Water Res. 2008, 42 (15), 4172-4178; Tartakovsky et al., Int. J. Hydrogen Energy 2009, 34 (2), 672-677; Call, et al., Environ. Sci. Technol., 2009, DOI: 10.1021/es803074x.). The H₂ production rate increased up to 8.0 m³-H₂/m³-d at an HRT of 1.6 h, which is the highest of reported values up to now in the MEC research field. The highest value reported before is 3.12 m³-H₂/m³-d (Call and Logan, 2008). The pattern of H₂ production rate to HRT was similar to that of the volumetric current density, which indicates that high organic loading rates (g acetate/d) driven by short HRT increase the current density and H₂ production rate in the single-chamber MEC. The applied voltage was 1.46-1.49 V when the high current density was achieved.

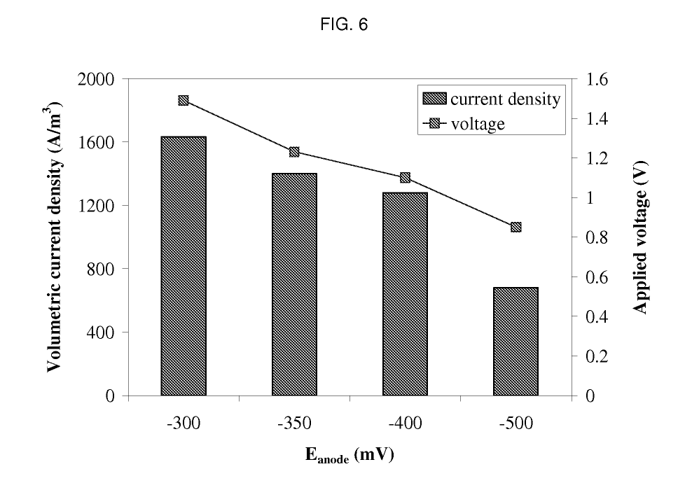

As E_{anode} was decreased, volumetric current density (H₂ production rate) and applied voltage declined (FIG. 6). These trends clearly support that E_{anode} can control acetate-oxidizing rate of ARB (Markus et al., 2007), reducing current density. As expected, the applied voltage became small when volumetric current density decreased. However, this still produced 680 A/m³ and 1.6 m³-H₂/m³-d at an applied voltage 0.8 V. This H₂ production rate is still three-fold higher than the maximum rate at applied voltage ˜1V in an MEC using graphite rods as the anode.

In summary, these results show the significance of large geometric surface area of the anode on current density and H₂ production rate in an MEC or BEC. Using the graphite small-fiber bundles as the electrodes efficiently increased volumetric current density and H₂ production rate, up to 1,633 A/m³ and 8.0 m³-H₂/m³-d at HRT at 1.6 h of HRT in the upflow single-chamber MEC lacking metal catalysts on the cathode. In addition, H₂ was produced at 1.6 m³-H₂/m³-d by only providing 0.8 V of applied voltage.

Advantageously, the approach employed herein to increase the H₂ production from MECs is different from the two previous approaches in that the current invention allows a much higher geometric surface area to be produced with the graphite small-fiber bundles. Specific surface area of one fiber bundle used in the invention is 191,300 m²/m³, which is over 10-fold larger than the previous graphite brush (Call and Logan, 2008). This surface area can be readily increased simply by adding more bundles to given systems without complex fabrication processes. In the examples provided above, three bundles were used, giving a total specific surface area of 573,900 m²/m³ and a volumetric rate of 8 m³-H₂/m³-d, which is approximately 3 times higher than the reported work by the Call and Logan (2008). Furthermore, the use of such increased surfaces areas in the electrode allows the preparation of efficient MECs that do not contain any metal-catalysts on the cathode, while all related-works have used platinum catalyst or other metal catalysts on the cathode.

### REFERENCES

The following references are herein incorporated by reference in their entirety.

Bond, D. R.; Lovley, D. R. Electricity Production by Geobacter sulfurreducens Attached to Electrodes. Applied and Environmental Microbiology, 2003, 69 (3), 1548-1555.

Call, D.; Logan, B. E. Hydrogen production in a single chamber microbial electrolysis cell lacking a membrane. Environmental Science & Technology 2008, 42 (9), 3401-3406.

Cheng, S.; Logan, B. E. Sustainable and efficient biohydrogen production via electrohydrogenesis. Proceedings of the National Academy of Sciences of the United States of America 2007, 104 (47), 18871-18873.

CRC, Handbook of Chemistry and Physics; 88th eds., 2008. http://www.hbcpnetbase.com/.

Hu, H.; Fan, Y.; Liu, H. Hydrogen production using single-chamber membrane-free microbial electrolysis cells. Water Research 2008 DOI 10.1016/j.watres.2008.06.015.

Lee, H. S.; Parameswaran, P.; Kato-Marcus, A.; Torres, C. I.; Rittmann, B. E., Evaluation of energy-conversion efficiencies in microbial fuel cells (MFCs) utilizing fermentable and non-fermentable substrates. Water Research 2008, 42 (6-7), 1501-1510.

Lee, H. S.; Salerno, M. B.; Rittmann, B. E., Thermodynamic evaluation on H-2 production in glucose fermentation. Environmental Science & Technology 2008, 42 (7), 2401-2407.

Marcus, A. K.; Torres, C. I.; Rittmann, B. E., Conduction-based modeling of the biofilm anode of a microbial fuel cell. Biotechnology and Bioengineering 2007, 98 (6), 1171-1182.

Ren, Z. Y.; Ward, T. E.; Regan, J. M., Electricity production from cellulose in a microbial fuel cell using a defined binary culture. Environmental Science & Technology 2007, 41 (13), 4781-4786.

Rittmann, B. E.; McCarty, P. L. Environmental Biotechnology: Fundamentals and 30 Applications. McGraw-Hill: New York, 2001, Chapter 13.

Rozendal, R. A.; Hamelers, H. V. M.; Molenkmp, R. J.; Buisman, J. N., Performance of single chamber biocatalyzed electrolysis with different types of ion exchange membranes. Water Research 2007, 41 (9), 1984-1994.

Rozendal, R. A.; Jeremiasse, A. W.; Hamelers, H. V. M.; Buisman, C. J. N., Hydrogen production with a microbial biocathode. Environmental Science & Technology 2008, 42(2), 629-634.

Rosenbaum et al., Appl. Cat. B. Environ., 74:261-269, 2007.

Qiao et al., Appl. Cat. B: Environ, 170:79-84, 2007.

Torres, C. I.; Kato Marcus, A.; Rittmann, B. E., Kinetics of consumption of fermentation products by anode-respiring bacteria. Applied Microbiology and Biotechnology 2007, 77(3),689-697.

Torres, C. I.; Marcus, A. K.; Rittmann, B. E. Proton transport inside the biofilm limits electrical current generation by anode-respiring bacteria. Biotechnology and Bioengineering 2008, 100 (5), 872-881.

1. A microbial electrolytic cell comprising:
a reservoir containing a fluid;
an organic donor material contained within the reservoir and supplied to the reservoir;
an anode submerged in the fluid;
anode-respiring bacteria proximal to the anode; and
a cathode,
wherein the anode and the cathode are each comprised of at least one bundle of non-bonded graphite small fibers.

2. The microbial electrolytic cell of claim 1, wherein said bundle of non-bonded graphite small fibers comprises between about 15,000 and 50,000 graphite fibers wherein each graphite small fiber independently comprises a length of 0.1-20 μm.

3. The microbial electrolytic cell of claim 1, wherein each graphite small fiber in said bundle independently comprises a length of from about 1-10 μm.

4-5. (canceled)

6. The microbial electrolytic cell of claim 1, wherein the ratio of anode:cathode bundles is between about 2:1 to about 5:1.

7. The microbial electrolytic cell of claim 1, wherein the anode electrode comprises about 3-10 bundles.

8. The microbial electrolytic cell of claim 1, wherein the cathode electrode comprises about 1-2 bundles.

9. The microbial electrolytic cell of claim 1, wherein the cathode electrode further comprises a metal catalyst, wherein said metal catalyst is selected from the group consisting of cobalt, copper, iron, nickel, palladium, tin, tungsten, platinum group metals, or an alloy comprising one of more of said group.

10. (canceled)

11. The microbial electrolytic cell of claim 1, further comprising a pump to circulate the fluid within the reservoir.

12. The microbial electrolytic cell of claim 1, wherein the organic donor material is selected from the group consisting of: glucose, cellulose, acetate, butyrate, lactate, propionate, or valerate.

13. The microbial electrolytic cell of claim 1, wherein the organic donor material is a waste organic material, wherein the waste material is selected from the group consisting of: sewage, human waste, animal waste, and industrial waste.

14. (canceled)

15. The microbial electrolytic cell of claim 1, wherein the anode-respiring bacteria transfer electrons extracted from the organic donor material to the anode, and wherein the microbial electrolytic cell is configured so that the electrons extracted from the organic donor material and transferred to the anode will react with H⁺ or H₂O to produce H₂ gas at the cathode.

16. (canceled)

17. The microbial electrolytic cell of claim 1, further comprising one or more of (a) a pH measurement device configured to measure the pH of the fluid contained within the reservoir; (b) a gas flow meter configured to measure and collect an amount of H₂ as produced by the microbial electrolytic cell; (c) a potentiostat configured to apply a voltage between 0.2 volts and 1.2 volts between the anode and the cathode; (d) a reference electrode electrically coupled to an electrical circuit comprising the cathode and the anode.

18. The microbial electrolytic cell of claim 1, wherein the anode and the cathode are less than 3.0 cm apart.

19-22. (canceled)

23. A microbial electrolytic cell comprising:
a reservoir containing a fluid;
an organic donor material contained within the reservoir;
an anode submerged in the fluid;
anode-respiring bacteria proximal to the anode; and
a cathode, wherein the cathode is located above the anode and proximal to an upper level of the fluid contained within the reservoir.

24. The microbial electrolytic cell of claim 23, wherein the anode and the cathode are not separated by a membrane.

25. The microbial electrolytic cell of claim 23, further comprising a pump to circulate the fluid within the reservoir. 26-37. (Cancelled)

38. The microbial electrolytic cell of claim 23 wherein said anode and said cathode are each comprised of at least one bundle of non-bonded graphite small fibers.

39-47. (canceled)

48. A method of producing hydrogen gas, the method comprising:
providing the microbial electrolytic cell of claim 1;
inducing a transfer of electrons from the organic donor material to the anode; and
reacting the electrons with H⁺ or H₂O proximal to the cathode to produce hydrogen gas.

49. The method of claim 48 wherein inducing the transfer of electrons from the organic donor material to the anode involves applying a voltage between the anode and the cathode.

50. A method of increasing the rate of hydrogen gas production in a microbial electrolytic cell comprising
providing the microbial electrolytic cell that comprises an anode, a cathode, a fluid reservoir, and a population of ARBs disposed on the anode, wherein at least the anode is comprised of at least one bundle of non-bonded graphite small fibers;
inducing a transfer of electrons from the organic donor material to the anode; and
reacting the electrons with H⁺ or H₂O proximal to the cathode to produce hydrogen gas;
wherein the microbial electrolytic cell comprising the anode of non-bonded graphite small fibers produces more hydrogen gas per minute than a similarly configured microbial electrolytic cell that comprises an anode prepared from a single graphite rod or an anode prepared from porous graphite.

51. The method of claim 50 wherein the cathode electrode of said microbial electrolytic cell is comprised of at least one bundle of non-bonded graphite small fibers.

52. The method of claim 51, wherein the cathode electrode further comprises a metal catalyst.
